(19) United States
(12) Patent Application Publication
(10) Pub. No.: US 2011/0248632 A1
(43) Pub. Date: Oct. 13, 2011

(54) Multi-Purpose Control Circuit

(76) Inventors: David Williams, Wales (GB); John Dingley, Wales (GB)

(21) Appl. No.: 12/671,938

(22) PCT Filed: Aug. 6, 2008
(86) PCT No.: PCT/GB08/02685

§ 371 Date: Jun. 20, 2011

(30) Foreign Application Priority Data
Aug. 7, 2007 (GB) 0715332.3

(51) Int. Cl. H05B 37/02

(52) U.S. Cl. 315/33

(57) ABSTRACT

A control circuit controls power supply to a device which includes a power storage device and an electricity generating means for intermittently supplying power to said storage device. The control circuit includes a microcontroller arranged to operate in either a sleep mode or an active mode when the device is switched on. The microcontroller intermittently enters the active mode from the sleep mode in order to test the storage device voltage and provide an indication if the storage device voltage is determined to be less than a predetermined level.

This invention relates to a multi-purpose light source which can be used in a range of different applications, including both medical and domestic.

### BACKGROUND OF THE INVENTION

1. Field of the Invention

Light sources in the form of torches utilising small Faraday generators are well known, in which an electromotive force is generated by moving a permanent magnet in a fixed coil to power Light Emitting Diodes (LEDs) or incandescent bulbs. Such devices are described in, for example, U.S. Pat. Nos. 4,114,305, 5,987,5714 and 6729744.

2. State of the Art

In many medical procedures, a bright light source is required for a short period of time, for example inspection of organs such as ears, eyes, nose and for carrying out procedures such as tracheal intubation using a laryngoscope. Conventional laryngoscopes have a light source which is provided by means of a handle containing batteries which operate an incandescent bulb such as tungsten filament bulb in the laryngoscope blade. International Patent Application No. PCT/GB2006/050148 describes a light source for use in medical procedures, which comprises a handle and a Faraday generator within the handle which powers a light emitting diode. Other instruments such as opthalmoscopes and otoscopes use a light source which shines directly into the eyes or ears when examining a patient are specifically designed for such a purpose and such instruments have a handle containing batteries which operate an incandescent bulb to provide the light required.

### SUMMARY OF THE INVENTION

It is an object of the present invention to provide an improved portable light source including a Faraday generator, in which a user is given a warning that stored charge is running low and a constant delivery of current to the LED is ensured to maximise efficiency.

In accordance with the present invention, there is provided a control circuit for a device comprising a power storage device and an electricity generating means for intermittently supplying power to said storage device, said control circuit comprising a microcontroller being arranged to operate in either a sleep mode or an active mode when said device is switched on, wherein said microcontroller is arranged and configured intermittently to enter said active mode from said sleep mode, test the storage device voltage and provide an indication if said storage device voltage is determined to be less than a predetermined level, and subsequently return to said sleep mode.

In one exemplary embodiment, the device may comprise a portable light source comprising a handle and a light emitting diode, said power storage element being connected to said light emitting diode, wherein said electricity generating means is mounted in or on said handle for supplying power to said power storage element.

The electricity generating means may comprise a Faraday generator, or other generator such as kinetic, piezo, solar cell, turbine, etc. The power storage element may comprise, for example, a battery, capacitor or fuel cell.

Beneficially, the control circuit comprises a current limiter for limiting the current supplied from said power storage element such that it maintains a substantially constant voltage output from said power storage device until the power storage element is substantially fully exhausted.

In the case where the device is a portable light source, this may be a torch, light source for medical applications or procedures, an emergency beacon, etc. However, the potential range of applications includes devices such as wrist watches, mobile phones, handheld or desk top computers, etc and the present invention is not necessarily intended to be limited in this regard, indeed, the present invention may be suitable for any electronic device that requires a high efficiency power generator, storage device and regulated power supply.

Also in accordance with the present invention, there is provided a control circuit for a portable light source device comprising a handle, a light emitting diode, a power storage element connected to said light emitting diode, and an electricity generating means mounted in said handle for supplying power to said storage element, said light emitting diode being rated at a voltage close to the voltage of said storage element when it is substantially fully exhausted, said circuit further comprising a current limiter between said storage element and said light emitting diode for limiting the current supplied to said light emitting diode from said storage element such that said light emitting diode operates at a substantially constant brightness until the voltage of said storage element is substantially fully exhausted.

The invention extends to a portable light source device comprising a handle, a light emitting diode, a power storage element connected to said light emitting diode, an electricity generating means mounted in said handle for supplying power to said storage element, and a control circuit as defined above.

In one exemplary embodiment, a watchdog timeout function is provided which causes said microcontroller to periodically enter said active mode. Preferably, means for switching said device on is provided, wherein actuation of said means causes said microcontroller to power up, enter said active mode and test said storage device voltage. Preferably, the microcontroller is arranged and configured to provide an indication if said storage device voltage is determined to be above said predetermined level. The indication provided to indicate the voltage level of said storage device is preferably provided by causing said light emitting diode to flash off and then on again one or more times. In one exemplary embodiment, the indication for indicating that the voltage level of said storage device is below said predetermined level is provided by causing said light emitting diode to intermittently flash off and then on again repeatedly. In this case, the “off” period is initially very short, and the light source is “on” for the majority of the time, so that the user is given a visible warning of low voltage level, but is still able to use the device as an effective light source. As the voltage level continues to fall, the duration of the “off” period steadily increases and the duration of the “on” period decreases. Thus, in practice, the light flashes off just for a moment, then stays on for, say, 5 seconds, then flashes off just for a moment and so in, the reason being that when the “low” warning is being given, the device can still continue to be effectively used as a light source because it is on for the majority of any “flash” cycle of this low-battery warning mode. The indication for indicating that the voltage level of said storage device is above said predetermined level is provided by causing said light emitting diode to flash off and then on again a number of times (e.g. 5) in quick succession.

Preferably the light emitting diode is supplied directly by the battery via means for switching said device on and off.

The microcontroller may determine the voltage level of said storage device by means of signal received from a high resistance potential divider. The sink of the light emitting diode is preferably via the microcontroller so that it can be flashed off and on at intervals as required.

The Faraday generator beneficially supplies power to the storage device (e.g. battery) via a bridge rectification or similar rectification (AC to DC conversion) device.

These and other aspects of the present invention will be apparent from, and elucidated with reference to, the embodiments described herein.

Embodiments of the present invention will now be described by way of examples only and with reference to the accompanying drawings.

### BRIEF DESCRIPTION OF THE DRAWINGS

FIG. 1 is a schematic block diagram illustrating the principle components of a portable light source unit according to an exemplary embodiment of the present invention;

FIG. 2 is a schematic side view of a portable light source unit according to an exemplary embodiment of the invention;

FIG. 3 is a schematic circuit diagram of an electric circuit suitable for use in the unit of FIG. 2;

FIG. 4 is a circuit diagram illustrating a circuit configuration suitable for use in the unit of FIG. 2;

FIG. 5 is a flow diagram illustrating an exemplary operation of the microcontroller of the circuit of FIG. 3; and

FIG. 6 is a state diagram illustrative of the basic operation illustrated in FIG. 5.

### DETAILED DESCRIPTION OF THE PREFERRED EMBODIMENT

Thus, the present invention provides a portable light source which is powered by utilising a Faraday generator. A charge storage element, such as a battery or capacitor, stores the charge generated by the Faraday generator and supplies the stored power to an LED. A control circuit is provided to ensure the provision of substantially constant intensity light and provide an indication of the charge status of the charge storage element.

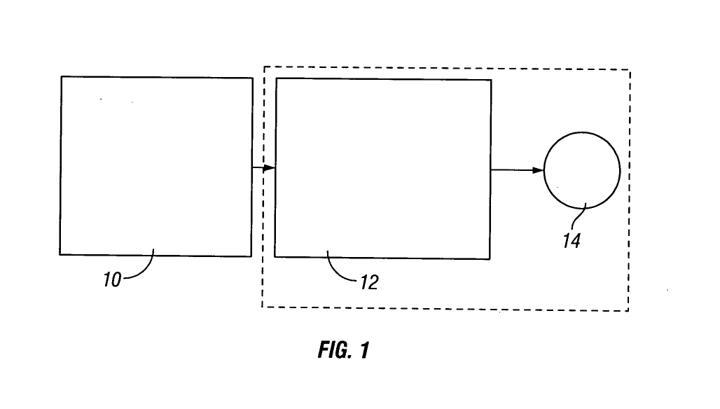

Referring to FIG. 1 of the drawings, a typical exemplary embodiment of the invention consists of three elements, namely a generator 10, a control unit 12 and an LED 14. As mentioned above, Faraday generators suitable for a portable light source application are known in the art and any one of these could be used in the present invention, which is not necessarily intended to be limited in this regard. In general, a suitable generator may comprise means for generating electricity by relative movement of at least one magnet and an electrically conductive wire to generate an electric current in the wire to power the LED. However, several suitable arrangements will be apparent to a person skilled in the art.

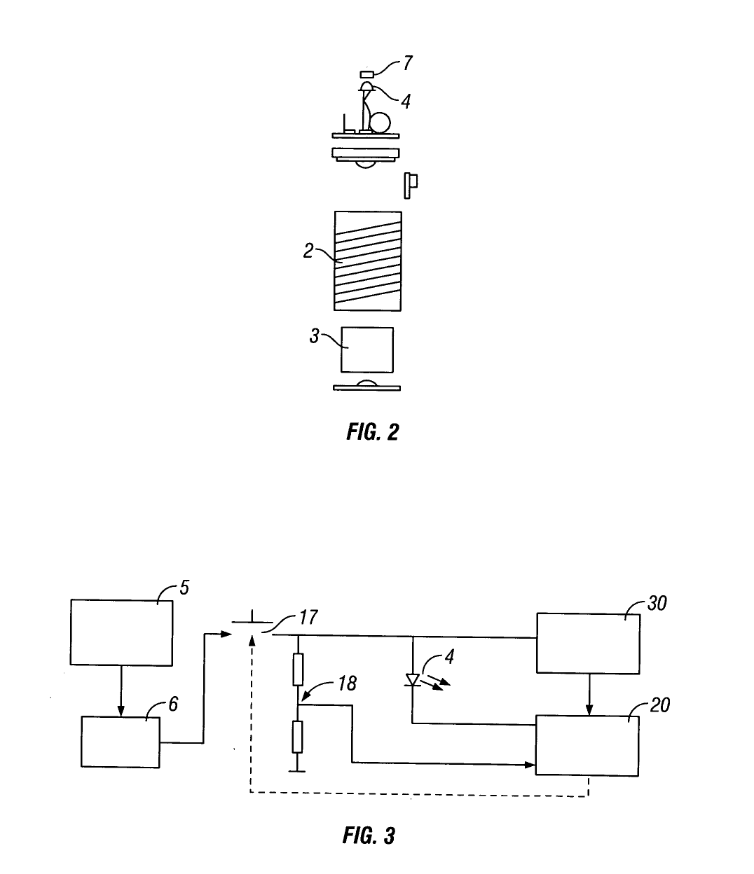

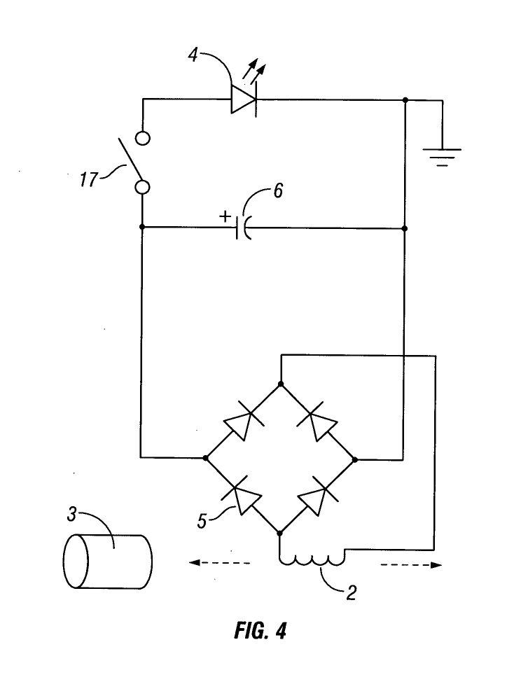

Referring to FIGS. 2 and 3 of the drawings, A portable light source according to an exemplary embodiment of the invention comprises a handle 1 in which there is a coil of wire 2 having a pathway down which cylindrical permanent magnet 3 can move. There is a light emitting diode 4 connected to the coil via an electric circuit comprising a bridge rectifier 5 and a battery 6, as shown in more detail in FIG. 4. There is an attachment means (not shown) connected to the handle 1 to which a head (not shown) can be attached. There is a light guide 7 from the LED 4 through the attachment means so that there is a continuous light path from the LED 4 to the head attached to the handle.

The bridge rectifier 5 acts as an AC/DC converter for the Faraday generator 2,3. The resulting current directly charges the battery 6. Referring additionally to FIG. 4 of the drawings, a suitable circuit may thus comprise the light emitting diode 4, an on/off switch 17, a rechargeable battery (or other charge storage element) 6, a bridge rectifier 5 to convert AC to DC and coil 2 in which the cylindrical magnet 3 moves. A zener diode (not shown) may be provided between the bridge rectifier and the charge storage element, in order to prevent over-charging, but in practice this is not necessary in many applications.

Referring back to FIG. 3 of the drawings, the circuit further comprises a high resistance potential divider 18 and a voltage regulator 30. Finally, a microcontroller 20 is provided, which is arranged and configured to receive inputs from the voltage regulator 30 and the potential divider 18. The switched supply (from the battery 6 via the switch 17) feeds the LED 4. The sink of the LED 4 is via the microcontroller 20 so that it can be flashed at intervals as required, as will be explained in more detail hereinafter. During operation, the ‘health’ of the battery 6 can be monitored by the microcontroller 20 via the high resistance potential divider 18, which does not provide a path to ground unless the microcontroller 20 is ON. The switch 17 is required to have a latching function, such that closing the switch 17 allows enough current for the microcontroller 20 to ‘wake up’ and then latch the power supply. As will be explained in more detail later, the switch 17 is preferably also monitored by the microcontroller 20 so that the next time it is pressed and released by a user, it causes the unit to be powered OFF.

As shown, the LED 4 uses the unregulated supply so that it maximises the available voltage. A current regulator function provided by the microcontroller operation ensures that the unit is being run at the optimum current, so a slight variation in voltage as a result of the fact that the LED 4 uses the unregulated supply will not have a perceptible effect on the light output. Finally, the switched supply also feeds the low dropout voltage regulator 30. The reason for this is that the microcontroller 20 is arranged to use an internal reference in proportion to its supply voltage to determine battery health. Obviously, if the battery supply were to be used to feed the voltage regulator, then the A/D reference would move in proportion to it and therefore always give the same result.

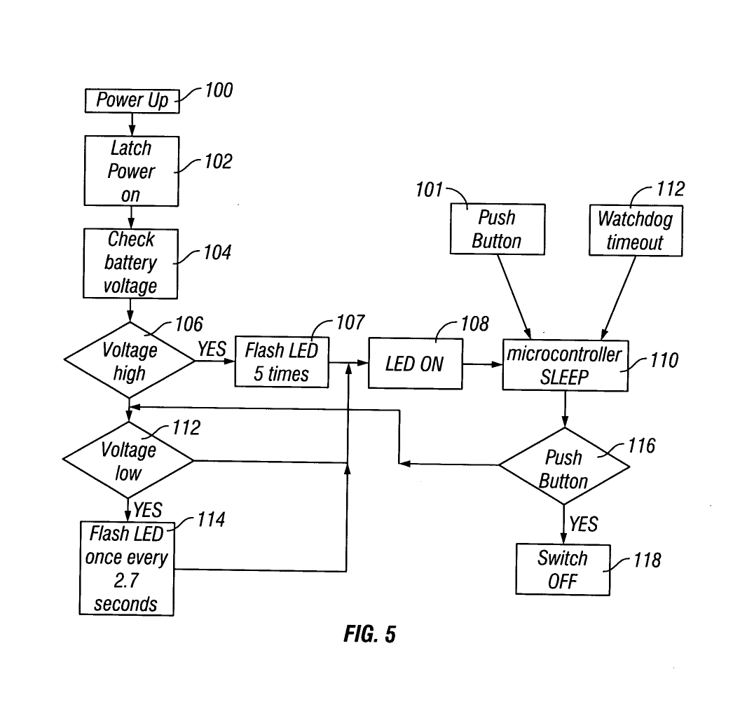

The microcontroller software is illustrated in the form of a flow chart, as shown in FIG. 5. When the switch 17 is first pressed to switch the unit on (101), a ‘power on’ event 100 occurs which causes the microcontroller 20 to wake up and latch the power supply (step 102). The microcontroller then checks the battery voltage using the battery health signal received from the high resistance potential divider 18. If the battery voltage is determined to be above a predetermined level (106), the microcontroller 20 causes the LED 4 to flash a number of times (in this case, 5) in quick succession before causing the LED 4 to operate in a normal mode, in which it outputs light at a substantially constant brightness (108). The microcontroller 20 then enters a sleep mode (110). A watchdog timeout function (112) is provided which causes the microcontroller to periodically wake up and re-test the battery health whilst the unit is powered on. If the microcontroller 20 determines that the battery voltage is below a predetermined level (step 112), it causes the LED to periodically flash off once for, say 200 ms (in this case every 2.7 seconds) 114, and the LED remains on at a substantially constant brightness in between such flashes (108).

If the switch 17 is pressed again (116), the unit is switched off (118).

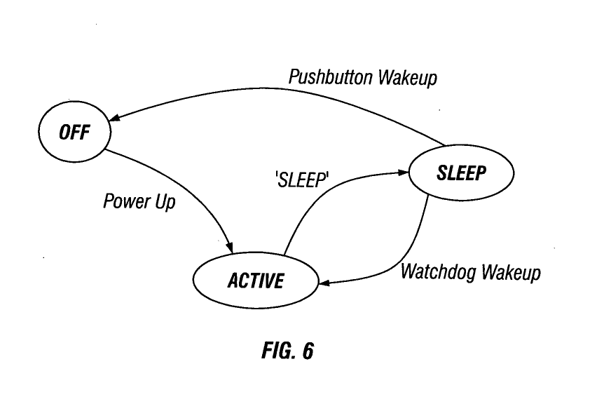

In summary, therefore, the microcontroller 20 is powered up in response to the on/off switch being pressed, performs a battery monitoring task and is then put in a sleep mode as soon as it has undertaken the battery monitoring task, in order to conserve power. It will come out of this sleep condition in response to a periodic watchdog wakeup event, check the battery health and then return to the sleep mode whilst the unit is powered on. The microcontroller 20 will also come out of this sleep condition if the on/off switch is pressed again. However, in this case, the intent must be to switch the unit off and the microcontroller facilitates this by clearing the reset registers, turning the LED off and then decoupling the power supply. A representative state diagram is given in FIG. 6.

The choice of LED for an exemplary embodiment of the present invention is significant. In a preferred embodiment, if the battery is rated at just over 4 volts, then a particularly suitable LED would be rated at around 3.1 volts (whereas typical LEDs tend to be rated at around 4 volts). Such an LED exists which operates at a high brightness but relatively low voltage (compared with typical LEDs). The battery will be almost completely exhausted before its voltage drops below 3.1 volts (if it is rated at just over 4 volts) which, in practice, means that via a current limiter to protect the LED when the battery is fully charged, the LED can be operated continuously at full brightness until the battery is almost fully exhausted. This is a significant advantage relative to known portable light sources of this type, which tend to gradually dim over time. Thus, even when the warning flashes start to occur, indicating that the battery is starting to run low and the unit needs to be shaken to charge the battery up, the unit is still outputting light at substantially the full brightness of the LED.

It will be appreciated that the present invention is suitable for many different types of portable light source applications, including those suitable for medical procedures, more general torch applications. The ability to program the microcontroller as required also means that the invention could be used for flashing emergency beacon type devices as well. Other applications will be apparent to a person skilled in the art, and the invention is not necessarily intended to be limited in this regard.

1. A control circuit for a device comprising a power storage device and an electricity generating means for intermittently supplying power to said storage device, said control circuit comprising:
a microcontroller being arranged to operate in either a sleep mode or an active mode when said device is switched on, wherein said microcontroller is arranged and configured intermittently to enter said active mode from said sleep mode, test the storage device voltage and provide an indication if said storage device voltage is determined to be less than a predetermined level, and subsequently return to said sleep mode.

2. A control circuit according to claim 1, the device being a portable light source comprising a handle and a light emitting diode, said power storage element being connected to said light emitting diode, wherein said electricity generating means is mounted in or on said handle for supplying power to said power storage element.

3. A control circuit according to claim 1, further comprising a current limiter for limiting the current supplied from said power storage element such that it maintains a substantially constant voltage output from said power storage device until the power storage element is substantially fully exhausted.

4. A control circuit according to claim 1, further comprising a watchdog timeout function which causes said microcontroller to periodically enter said active mode.

5. A control circuit according to claim 1, further comprising means for switching said device on, wherein actuation of said means causes said microcontroller to power up, enter said active mode and test said storage device voltage.

6. A control circuit according to claim 1, wherein the microcontroller is arranged and configured to provide an indication if said storage device voltage is determined to be above said predetermined level.

7. A control circuit according to claim 6, wherein the indication provided to indicate the voltage level of said storage device is above said predetermined level is provided by causing a light emitting diode to flash off and then on again one or more times.

8. A control circuit according to claim 7, wherein the indication for indicating that the voltage level of said storage device is below said predetermined level is provided by causing said light emitting diode to intermittently flash off and then on again repeatedly.

9. A control circuit according to claim 8, wherein the period during which said light emitting diode is off increases and the period during which said light emitting diode is on decreases as the storage element becomes more exhausted.

10. A control circuit according to claim 6, wherein the indication for indicating that the voltage level of said storage device is above said predetermined level is provided by causing said light emitting diode to flash off and then on again a number of times in quick succession.

11. A control circuit according to claim 1, wherein the microcontroller determines the voltage level of said storage device by means of signal received from a high resistance potential divider, and the sink of the light emitting diode is controlled by the microcontroller so that the light emitting diode can be flashed off and on at intervals as required.

12. A control circuit according to claim 1, wherein the electricity generator supplies power to the storage device via an AC to DC conversion.

13. A control circuit for a portable light source device comprising a handle, a light emitting diode, a power storage element connected to said light emitting diode, and an electricity generating means mounted in said handle for supplying power to said storage element, said light emitting diode being rated at a voltage close to the voltage of said storage element when it is substantially fully exhausted, said circuit further comprising a current limiter between said storage element and said light emitting diode for limiting the current supplied to said light emitting diode from said storage element such that said light emitting diode operates at a substantially constant brightness until the voltage of said storage element is substantially fully exhausted.

14. A portable light source device comprising a handle, a light emitting diode, a power storage element connected to said light emitting diode, an electricity generating means mounted in said handle for supplying power to said storage element, and a control circuit according to claim 1.

15. A device according to claim 14, wherein the light emitting diode is supplied directly by the battery via means for switching said device on and off.

16. (canceled)
